(19) United States
(12) Patent Application Publication
(10) Pub. No.: US 2018/0261056 A1
(43) Pub. Date: Sep. 13, 2018

(54) ANTI-THEFT SYSTEM FOR WALL-MOUNT HVAC UNIT

(71) Applicant: Bard Manufacturing Company, Inc., Bryan, OH (US)

(72) Inventors: James L. Austermiller, Defiance, OH (US); Darryll Jones, Bryan, OH (US); Sean David Skiver, Defiance, OH (US)

(21) Appl. No.: 15/915,736

(22) Filed: Mar. 8, 2018

Related U.S. Application Data
(60) Provisional application No. 62/469,039, filed on Mar. 9, 2017.

(51) Int. Cl. G08B 13/08; F24F 1/56; F24F 1/62

(52) U.S. Cl. CPC G08B 13/08; F24F 1/62; F24F 1/56

(57) ABSTRACT

A theft deterrent system is disclosed. The theft deterrent system includes a frame having a top piece, a bottom piece, and two side pieces. The frame is configured to attach to an outer housing of an HVAC unit. The theft deterrent system includes at least one fastener configured to secure the top piece of the frame to one of the side pieces of the frame. The theft deterrent system also includes an electronic system configured to notify a user upon unauthorized entry to the HVAC unit.

### CROSS-REFERENCE TO RELATED APPLICATIONS

This application claims priority to U.S. Provisional Application No. 62/469,039 filed Mar. 9, 2017, which is hereby incorporated by reference in its entirety.

### BACKGROUND

### A. Field

This disclosure relates generally to theft deterrent systems, and more particularly to a theft deterrent system for protecting a wall-mount HVAC unit.

### B. Description of Related Art

Commercial HVAC units can be mounted to an exterior wall of a building, such as a telecom shelter. The coils used in these units are made of valuable metals such as copper and aluminum, and therefore have become a target of theft. Thus, a need has arisen for an anti-theft or theft deterrent system to be installed on the HVAC units in order to deter and prevent thieves from removing the coils from the units.

### SUMMARY

The following embodiments and aspects thereof are described and illustrated in conjunction with systems, tools and methods which are meant to be exemplary and illustrative, not limiting in scope.

In one aspect, a theft deterrent system is disclosed. The theft deterrent system includes a frame having a top piece, a bottom piece, and two side pieces, the frame being configured to attach to an outer housing of an HVAC unit, at least one fastener configured to secure the top piece of the frame to one of the side pieces of the frame; and an electronic system configured to notify a user upon unauthorized entry to the HVAC unit.

In another aspect, a system is disclosed. The system includes an HVAC unit having an outer housing and a frame secured to the outer housing of the HVAC unit. The frame includes a top piece, a bottom piece, two side pieces, and at least one fastener configured to secure the top piece of the frame to one of the side pieces of the frame. The system further includes at least one sensor mounted to the outer housing, a controller configured to receive a signal from the at least one sensor, and a speaker in communication with the controller. When the controller loses the signal from the at least one sensor, an alarm or message sounds via the speaker for a preset period of time.

In another aspect, a theft deterrent frame is disclosed. The theft deterrent frame includes a top piece, a bottom piece, and two side pieces, the frame being configured to attach to an outer housing of an HVAC unit. The frame also includes at least one non-standard fastener configured to secure the top piece of the frame to one of the side pieces of the frame. Each piece of the frame is secured to the outer housing via an attachment mechanism, and the top piece, a bottom piece, and two side pieces each have at least one of a tab having a groove or a post located thereon for connection to an adjacent piece.

In addition to the exemplary aspects and embodiments described above, further aspects and embodiments will become apparent by reference to the drawings and by study of the following detailed description.

### BRIEF DESCRIPTION OF THE DRAWINGS

Exemplary embodiments are illustrated in the drawings. It is intended that the embodiments and figures disclosed herein are to be considered illustrative rather than restrictive.

FIG. 1A is a perspective view of an example HVAC unit including a theft deterrent system according to one embodiment of the disclosure;

FIG. 1B is a perspective view of the theft deterrent frame shown in FIG. 1A;

FIG. 2 is a perspective view of a piece of the theft deterrent frame shown in FIG. 1B;

FIG. 3 is a perspective view of another piece of the theft deterrent frame shown in FIG. 1B;

FIG. 4 is a top view of the piece of the frame shown in FIG. 2;

FIGS. 5A, 5B, and 5C are perspective views of the theft deterrent frame in an open position;

FIGS. 5D, 5E, and 5F are perspective views of the theft deterrent frame in a closed position;

FIG. 6 is a perspective view of an example HVAC unit including a theft deterrent system according to another embodiment of the disclosure;

FIG. 7 is a front view of an example controller according to one embodiment;

FIG. 8 is an example wiring diagram of the controller of FIG. 7;

FIG. 9 is an example wiring diagram of additional components of the electronic theft deterrent system according to one embodiment; and

FIG. 10 is a perspective view of an example security board according to one embodiment.

### DETAILED DESCRIPTION

The present application discloses an anti-theft or theft deterrent system for a wall-mount HVAC unit. In one embodiment, the system may include both mechanical and electronic devices for preventing theft, and for notifying a unit owner of unauthorized unit entry. In another embodiment, only the mechanical aspect of the theft deterrent system may be included. An example mechanical system may include a large interlocking metal frame that encapsulates the unit's front access panels. An example electronic system may include a combination of panel removal detecting sensors and a very low pressure switch wired to a control box that generates alarms.

In one example application, the anti-theft system may be used in a wall mount HVAC or air conditioning unit having an enclosure or cabinet, an evaporator coil assembly, and a condenser coil assembly. The cabinet may be mounted to the outer wall of a structure such as a school, a data center, or a telecom equipment shelter, for example. A typical unit may include an outer housing or cabinet with a number of access panels for access to the interior of the unit. Inside the cabinet, the evaporator coil assembly may be mounted in the upper portion of the unit, and the condenser coil assembly may be mounted in the lower portion of the unit, or vice versa.

One embodiment of the theft deterrent system of the present disclosure may include one or more metal braces bolted to the perimeter of the unit, which may prevent the entire unit 100 from being opened or accessed. In some embodiments, the system may further require nonstandard tooling for accessing the fasteners to prevent removal of the condenser and evaporator coils. Additionally, an electronic component, such as an array of sensors, may be connected to the unit to detect unauthorized removal of a panel and to monitor the state of the unit. If the state of the unit changes, such as if a change in pressure is detected, the sensors indicate an attempt to remove one or both of the coil assemblies, and an alarm may sound using a speaker and send a signal to a remote location, such as a network operating center.

Therefore, the mechanical aspect of the theft deterrent system may be constructed as a metal frame to hinder or complicate entry into the unit. The externally mounted frame functions for both cabinet security as well as a visual deterrent. The metal frame may be mounted to the top and to the sides. When the frame is installed, removal of either refrigeration coil is greatly hindered. The frame may be designed to remain attached to the unit at all times for safety and ease of use. Each frame may include non-standard or specialty fasteners to prevent attempts at cutting the fastener or removal without the required tool.

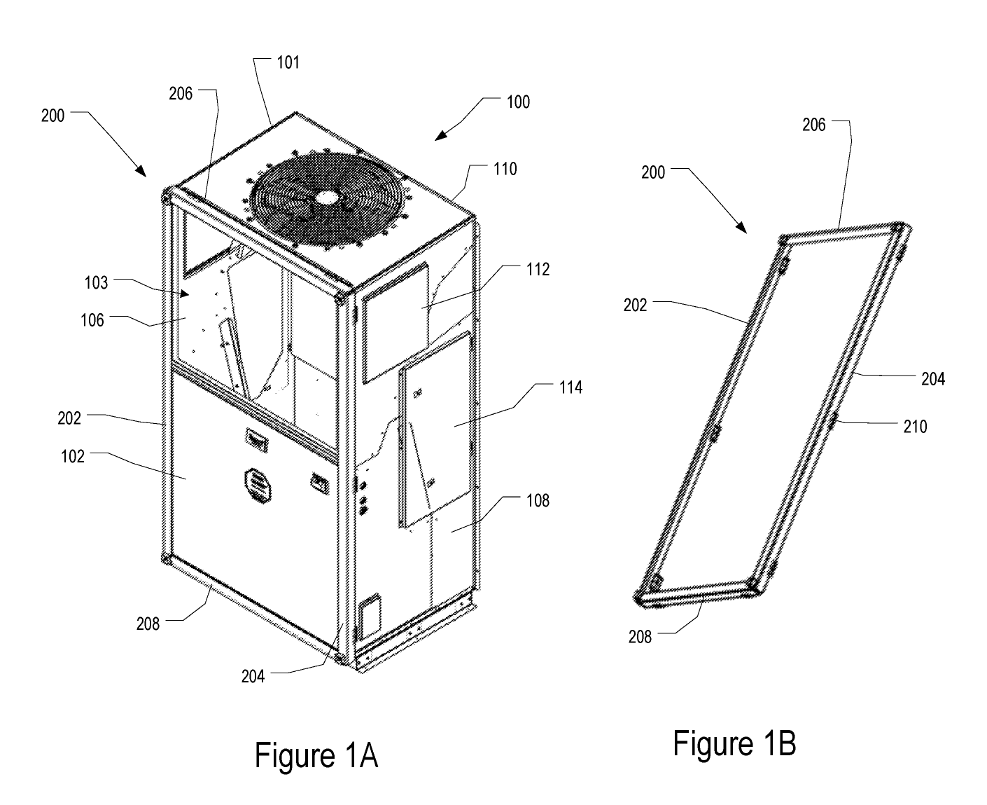

Referring to FIG. 1A, an HVAC unit 100 includes an outer housing 101 which includes a front access panel 102, side panels 106, 108, a top panel 110, and a bottom panel (not shown). The side panels 106, 108 may each include one or more side access panels 112 and 114. Each of the access panels provides access to the interior 103 of the unit 100. In some embodiments, a front grill (not shown) is located above the front access panel 102.

In order to protect the materials located in the interior 103 of the unit 100, the unit may be equipped with a theft deterrent system. As mentioned above, a component of the theft deterrent system may be in the form of a metal frame 200 mounted to the top, bottom, front, and/or sides of the unit 100. The frame 200, shown in FIGS. 1-5, may include two side pieces 202, 204, a top piece 206, and a bottom piece 208. The pieces 202, 204, 206, 208 are removably connected together around a portion of the outside of the HVAC unit 100. Although the frame 200 is shown to be secured to the top, bottom, and side panels of the unit 100, it should be understood that the frame 200 may be secured to more or less portions of the unit 100.

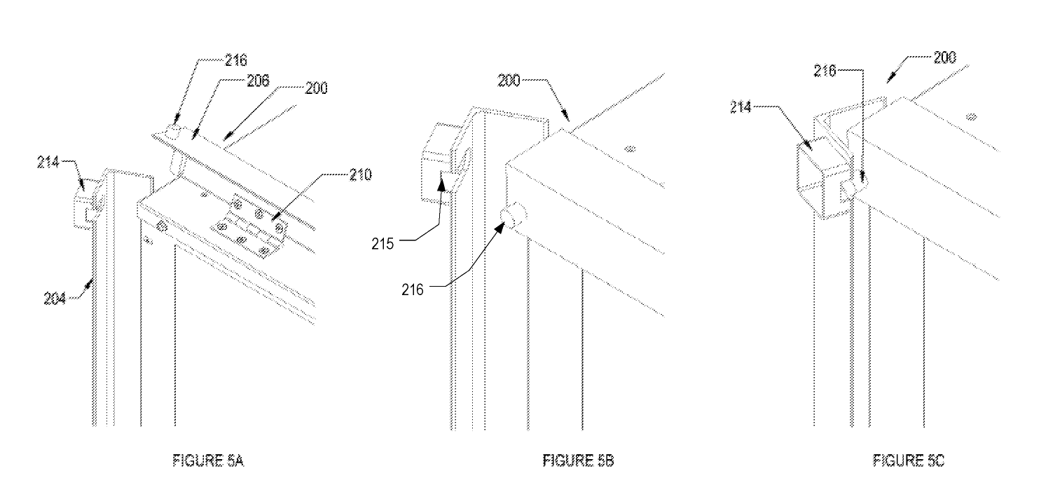

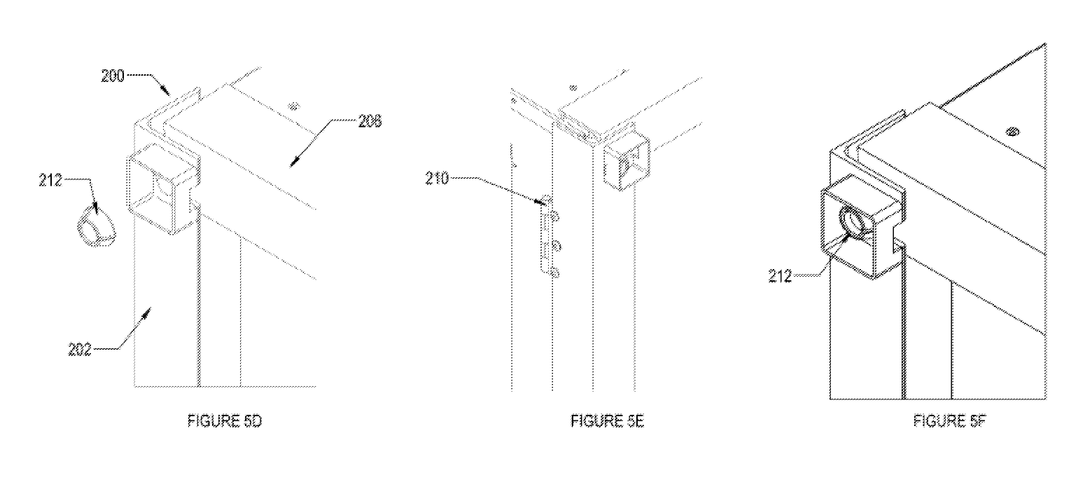

In an example embodiment, shown in FIGS. 1B and 2-4, each frame piece 202, 204, 206, 208 may be pivotably connected to the unit 100, and may include one or more hinges 210 attached thereto. Thus, each of the pieces of the frame can independently hinge away from the front of the unit 100, as shown in FIG. 5A. In some embodiments, the hinges 210 may be mounted onto the interior of the frame pieces 202, 204, 206, 208 to prevent tampering or removal. It should be understood that in alternate embodiments, the frame pieces may be secured to the unit 100 by any known connection mechanism.

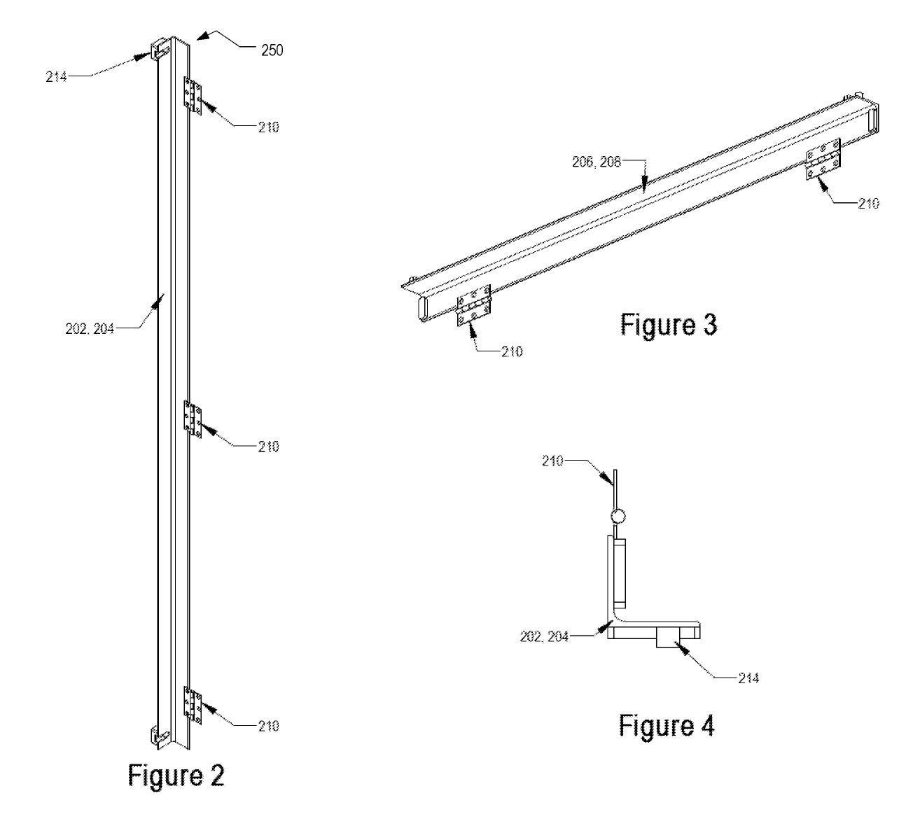

In one embodiment, the frame pieces 202, 204, 206, 208 may be connected together at the corners of the unit 100. Referring to FIGS. 2, 4, and 5, the pieces 202, 204, 206, 208 may each include a locking mechanism, such as a tab 214 having a groove or channel 215, and/or a post 216 to facilitate the interlocking of the pieces to each other. In some embodiments, the tab 214 and/or post 216 may be located at or near an end of each of the pieces. In alternate embodiments, the tab 214 and/or post 216 may be located at other positions along the pieces, as long as the tabs and posts of separate pieces can interlock with each other. In other embodiments, any suitable locking mechanism can be used to interlock the pieces together.

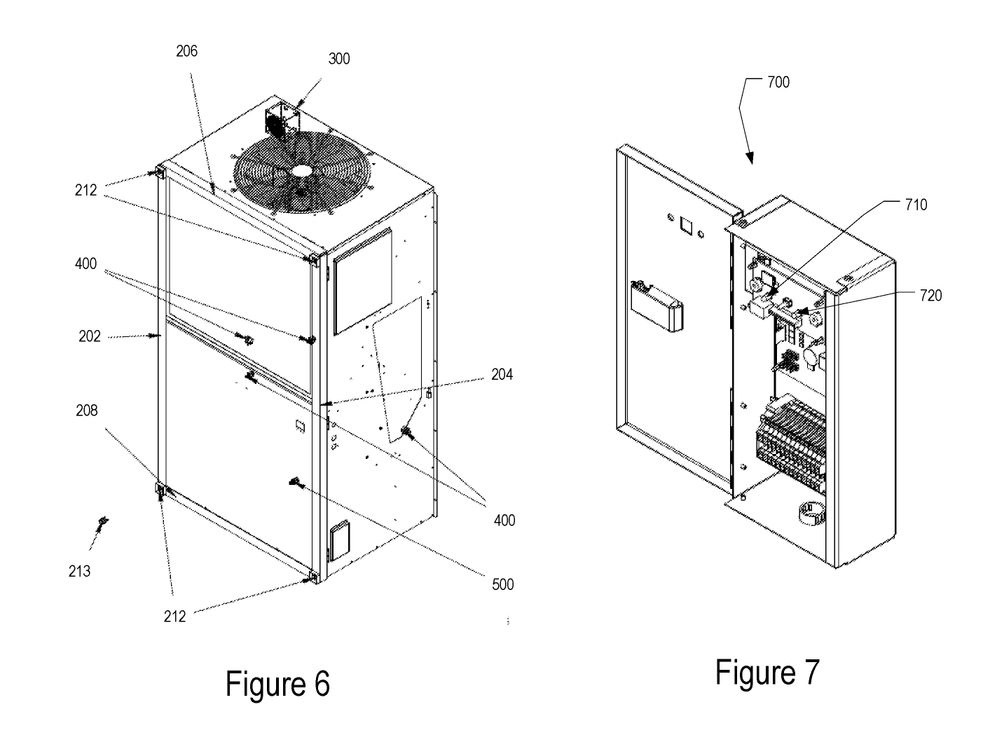

The pieces 202, 204, 206, and 208 may then be secured to each other with one or more fasteners 212. In order to increase security, the fasteners 212 may be non-standard fasteners that require a non-standard, specialized tool for insertion and removal, such as a specialty bolt or nut, for example. In one example, the fastener 212 may be a tri-groove nut which can be locked and unlocked with a tri-groove socket 213 (shown in FIG. 6). In another example, a tamper resistant screw or deadbolt lock requiring a key may be used. It should be understood that in other embodiments, any suitable specialty or non-specialty fastener may be used. The fasteners 212 may be designed such that they must be completely removed prior to internal unit access by an authorized technician.

Referring to FIGS. 5A-5F, the connection between two of the frame pieces on the unit 100 is shown. The pieces 202, 204, 206, 208 are positioned on the outside of the unit 100 with the hinges 210 placed against the unit wall, as shown in FIGS. 5A and 5B. Next, the post 216 of one piece is inserted into the groove 215 of a tab 214 of another piece, as shown in FIG. 5C. A specialty fastener 212 is then inserted over the post to secure the pieces in place, as shown in FIGS. 5D-5F.

In one example embodiment, the frame pieces 202, 204, 206, 208 may be made of metal, such as steel or stainless steel, for example. It should be understood that the frame pieces may alternatively be constructed of other suitable metals, such as aluminum, for example. Additionally, in some embodiments, the frame pieces 202, 204, 206, 208 may have dimensions of about 2×2×⅛″. It should be understood that the frame pieces may alternatively have other suitable dimensions as well to fit onto different sized housings.

As mentioned above, in some embodiments, an electronic theft deterrent system can be installed on a unit 100 in addition to or instead of the frame 200. In this embodiment, a series of sensors, such as door/panel switches 400 and very low pressure switches 500, may be wired in series and attached to the sides of the housing 101 of the unit 100, and/or directly to the copper or aluminum coils located in the interior 103 of the unit. The sensors monitor the state of the unit 100. FIG. 6 shows example door/panel switches 400 and an example low pressure switch 500 installed on the unit 100. In some embodiments, other known sensors may be used in addition to or instead of the switches 400 and 500, such as omni-directional tilt sensors, for example.

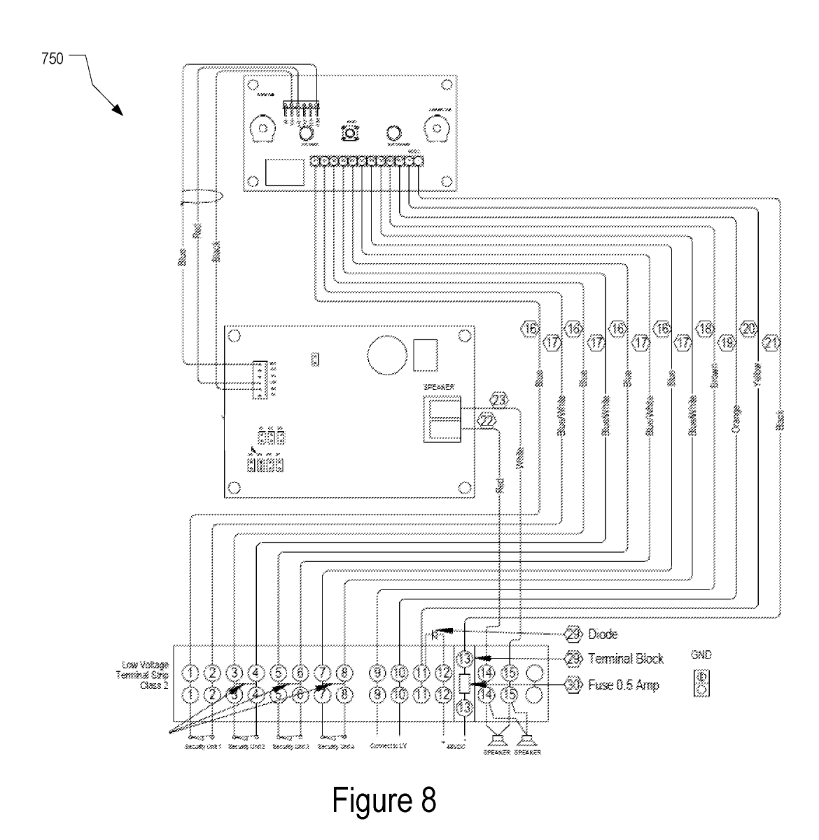

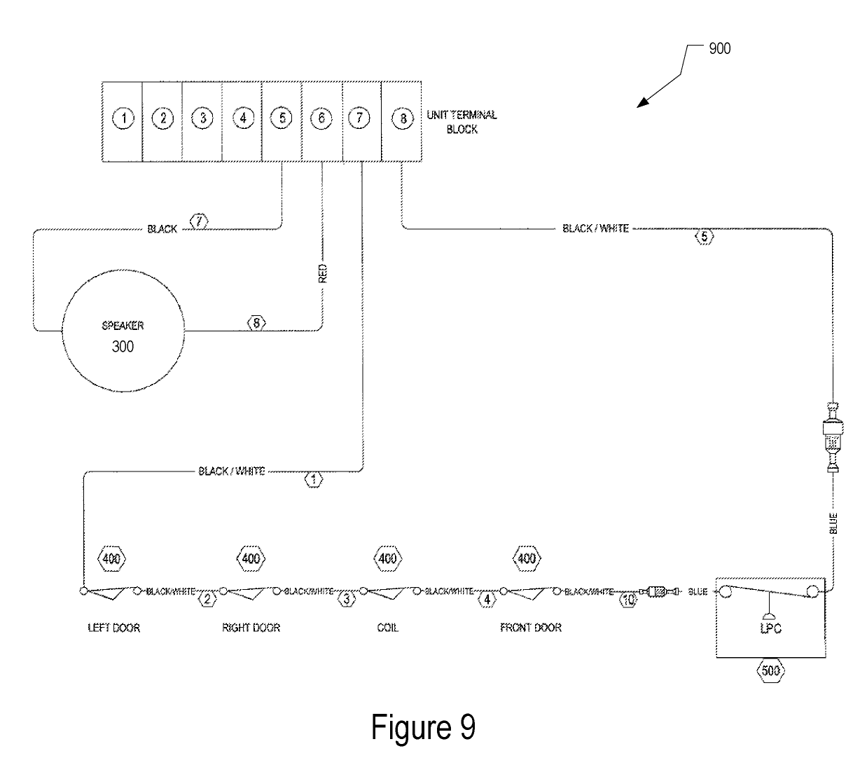

FIG. 7 shows an example controller 700. The controller 700 may be installed anywhere inside a building or equipment shelter that is suitable, preferably at eye level and near the main controller (not shown) inside the shelter that controls the HVAC units 100. The shelter is locked with restricted access. The controller 700 is connected to and receives power from the main controller. The controller 700 includes a fused power supply terminal in a terminal block. The door/panel switches 400 and the low pressure switches 500 are wired in series and terminated at two terminals, such as terminals 7 and 8, on the terminal block inside the unit 100. Up to four (4) units 100 can be connected to a single controller 700. FIG. 8 shows an example wiring diagram 750 of the controller 700. FIG. 9 shows an example wiring diagram 900 for a plurality of sensors 400, 500 and speaker 300 which are wired to the unit 100.

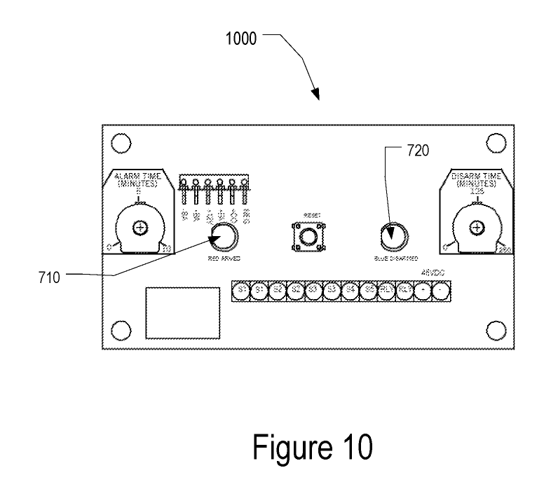

In operation, the controller 700 is enabled in the main controller of the unit 100. When the system powers up for the first time, the theft-deterrent system and controller 700 arms automatically. Once all sensors are satisfied (circuits closed), an indicator light 710, which may be a red LED, is illuminated on the controller 700, indicating that the system is armed. When any of the sensors 400 or 500 are not satisfied (i.e., the circuit is open), the indicator light will turn off and an alarm will sound. In one embodiment, the alarm may comprise a prerecorded message. The alarm may continue to sound for a preset period of time for up to 10 minutes, for example. The preset time period may be adjusted on a security board 1000 (shown in FIG. 10, described below). In one example, the default time may be approximately 2½ minutes. The alarm may be acknowledged by a user pressing the alarm key, which calls up an anti-theft alarm display screen. When the input no longer indicates a theft, the alarm may automatically clear and the display screen will return to its normal state. Additionally, the main controller may send a signal to a remote network operating center. Thus, personnel at the remote network center are made aware of a possible security breach.

The controller 700 has to be disarmed before attempting to open or service the units 100 in order to avoid the alarm being triggered. To disarm the system, a disarm/reset button on the security board 1000 may be pressed. A second LED 720 with a different color than the indicator light, such as a blue LED, may then be illuminated. As long as the blue LED is illuminated, the system is disarmed. Once disarmed, the anti-theft system may remain off for a period of time, such as for about 4 hours, for example. The system can be manually re-activated before the preset time. If the system is not manually reactivated when in the disarmed state, then the system may automatically rearm after the preset time.

The door/panel switches 400 monitor the doors/panels 106, 108 of the unit 100, such that when the switches 400 detect movement of the panels, a signal is sent to the controller 700, which activates an alarm or message to sound using an electronic sound driver board driving a speaker 300 located on the top panel 110 of the unit 100. In other embodiments, the speaker 300 may be located anywhere in or on the unit 100. The message may broadcast a pre-recorded audible warning in both English and Spanish, for example. In some embodiments, the message may be broadcast in other languages.

The very low pressure switch 500 may be constructed to detect a sudden loss of refrigerant pressure. This pressure monitoring system may be used to detect a loss in refrigerant pressure in the tubes connected to the condenser coil and/or the evaporator coil. If the condenser coil assembly and/or the evaporator coil assembly is forcibly removed, causing a sudden rapid loss of pressure, the low pressure switch is activated and sends a signal to the controller 700, which activates an alarm or message to sound over the speaker 300 as noted above.

In some embodiments, in addition to the alarm or message, a signal is sent to a remote network operating center through a custom built electronic board or security board 1000, shown in FIG. 10, located within the controller 700. The security board 1000 takes input from the sensors and communicates the output to the speaker 300 and to the remote network center or monitoring system.

When an omni-directional tilt sensor is used in the theft deterrent system, the alarm or message is triggered when the sensor detects that the unit 100 is no longer parallel to the ground. Any type of known omni-directional tilt sensor may be used.

Additionally, in some embodiments, plunger switches and/or omni-directional sensors may be used to detect unauthorized removal of the panels covering the air conditioner unit. One or more plunger switches and/or omni-directional sensors may be placed inside any or all of the access panels or doors of the unit 100. If one or more panels covering the condenser coil assembly and or the evaporator coil assembly are removed (without disarming the controller inside the shelter) from the unit, the switches and/or sensors may trigger an alarm to sound through the speaker, and may also send a signal to a remote network operating center and to the police to indicate a possible breach of the building or shelter. This notification may also broadcast in both English and Spanish, or in any other language.

In one example embodiment, four plunger switches are installed in series in four different panels of the HVAC unit 100. If someone attempts to open any of the four panels, the alarm is triggered. It should be understood that in alternate embodiments any number of sensors or switches may be used.

In an alternate embodiment, the metal frame 200 and/or electronic system may be retrofit onto an existing HVAC unit.

While a number of exemplary aspects and embodiments have been discussed above, those of skill in the art will recognize that still further modifications, permutations, additions and sub-combinations thereof of the features of the disclosed embodiments are still possible. It is therefore intended that the following appended claims and claims hereafter introduced are interpreted to include all such modifications, permutations, additions and sub-combinations as are within their true spirit and scope.

1. A theft deterrent system comprising:
a frame having a top piece, a bottom piece, and two side pieces, the frame being configured to attach to an outer housing of an HVAC unit;
at least one fastener configured to secure the top piece of the frame to one of the side pieces of the frame; and
an electronic system configured to notify a user upon unauthorized entry to the HVAC unit.

2. The system of claim 1 further comprising at least one hinge configured to attach the top piece of the frame to the HVAC unit.

3. The system of claim 2 wherein the at least one hinge is secured to an interior of the top piece.

4. The system of claim 1 wherein the top piece and the bottom piece each have two hinges secured thereto, and wherein the two side pieces each have three hinges secured thereto.

5. The system of claim 1 wherein the top piece, a bottom piece, and two side pieces each have a locking mechanism located thereon for connection to an adjacent piece.

6. The system of claim 1 further comprising four fasteners configured to secure the top piece, the bottom piece, and the two side pieces together.

7. The system of claim 1 wherein the fastener is a tri-groove nut.

8. The system of claim 1 wherein the fastener is a dead bolt.

9. The system of claim 1 wherein the electronic system comprises a plurality of sensors positioned on the HVAC unit and a controller configured to receive signals from the plurality of sensors.

10. The system of claim 9 wherein the plurality of sensors includes at least one panel switch and at least one pressure switch.

11. The system of claim 9 wherein upon receipt of a signal from one of the plurality of sensors, an alarm or message sounds via a speaker and a second signal is sent to a remote operating center.

12. The system of claim 1 wherein each of the frame pieces is constructed of metal.

13. A system comprising:
an HVAC unit having an outer housing;
a frame secured to the outer housing of the HVAC unit, the frame comprising:
a top piece, a bottom piece, and two side pieces; and
at least one fastener configured to secure the top piece of the frame to one of the side pieces of the frame;
at least one sensor mounted to the outer housing;
a controller configured to receive a signal from the at least one sensor; and
a speaker in communication with the controller;
wherein when the controller loses the signal from the at least one sensor, an alarm or message sounds via the speaker for a preset period of time.

14. The system of claim 13 wherein each piece of the frame is pivotably secured to the outer housing.

15. The system of claim 13 wherein the at least one fastener comprises a non-standard fastener.

16. The system of claim 13 wherein the at least one sensor comprises one of a panel switch, a low pressure switch, a plunger switch, an omni-directional sensor, or an omni-directional tilt sensor.

17. The system of claim 13 wherein when the controller loses the signal from the at least one sensor, a second signal is sent to a remote operating center.

18. A theft deterrent frame comprising:
a top piece, a bottom piece, and two side pieces, the frame being configured to attach to an outer housing of an HVAC unit;
at least one non-standard fastener configured to secure the top piece of the frame to one of the side pieces of the frame;
wherein each piece of the frame is secured to the outer housing via an attachment mechanism; and
wherein the top piece, a bottom piece, and two side pieces each have at least one of a tab having a groove or a post located thereon for connection to an adjacent piece.

19. The theft deterrent frame of claim 18 wherein the non-standard fastener is a tri-groove nut or a dead bolt.

20. The theft deterrent frame of claim 18 wherein each of the frame pieces is constructed of metal.
